(19) United States
(12) Patent Application Publication
(10) Pub. No.: US 2003/0204731 A1
(43) Pub. Date: Oct. 30, 2003

(54) Method and apparatus to enhance the security of data

(76) Inventors: Denis A. Pochuev, Camas, WA (US); Trevor A. Wells, Vancouver, WA (US); Robert P. Walrath, Battle Ground, WA (US)

Correspondence Address: HEWLETT-PACKARD COMPANY, Intellectual Property Administration, P.O. Box 272400, Fort Collins, CO, 80527-2400, US

(21) Appl. No.: 10/136,010

(22) Filed: Apr. 29, 2002

(51) Int. Cl. H04L 9/00

(52) U.S. Cl. 713/181; 713/150

(57) ABSTRACT

A method includes generating data with an imaging system in response to a request from an information source and decrypting encrypted information received from the information source, using the imaging system and at least part of the data, to form decrypted information. In addition, the method includes forming a second hash from the decrypted information using the imaging system. Furthermore, the method includes forming an image on media using the decrypted information if the second hash equals a first hash received from the information source.

### INTRODUCTION

Sometimes a user wishes to form an image on media of a document or a picture, using a communication channel that is not secure. The communications channel could include, for example, a wireless link, a local network, or a wide array network such as the Internet. Data defining the image is sent over the communication channel to an imaging device, such as facsimile machine, copier, plotter, or a printer, for formation of the image. In attempt to ensure that the information in the document or image is not viewed by an unauthorized person, the user may use encryption techniques on the data defining the image. However, in some cases, even encrypted information that is copied during its transmission over the communications channel and resent at a later time can result in an unauthorized person having access to the information. Improved techniques for the delivery of data to imaging devices over communication channels will enhance security.

### SUMMARY OF THE INVENTION

A method includes generating data with an imaging system in response to a request from an information source and decrypting encrypted information received from the information source, using the imaging system and at least part of the data, to form decrypted information. In addition, the method includes forming a second hash from the decrypted information using the imaging system. Furthermore, the method includes forming an image on media using the decrypted information if the second hash equals a first hash received from the information source.

### DESCRIPTION OF THE DRAWINGS

A more thorough understanding of embodiments of the security system may be had from the consideration of the following detailed description taken in conjunction with the accompanying drawings in which:

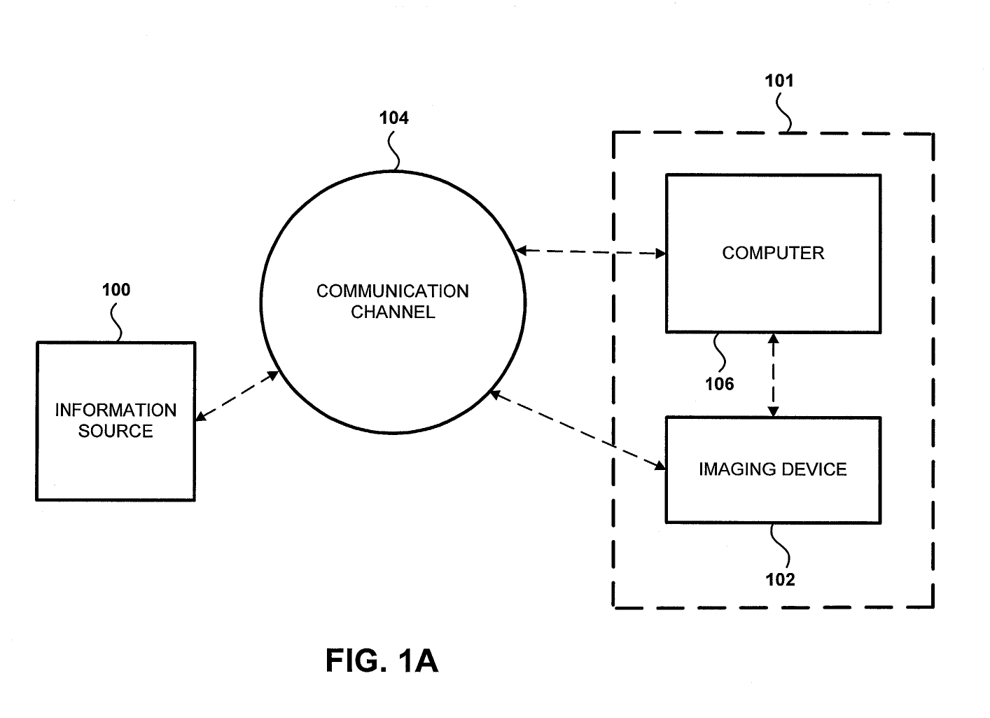

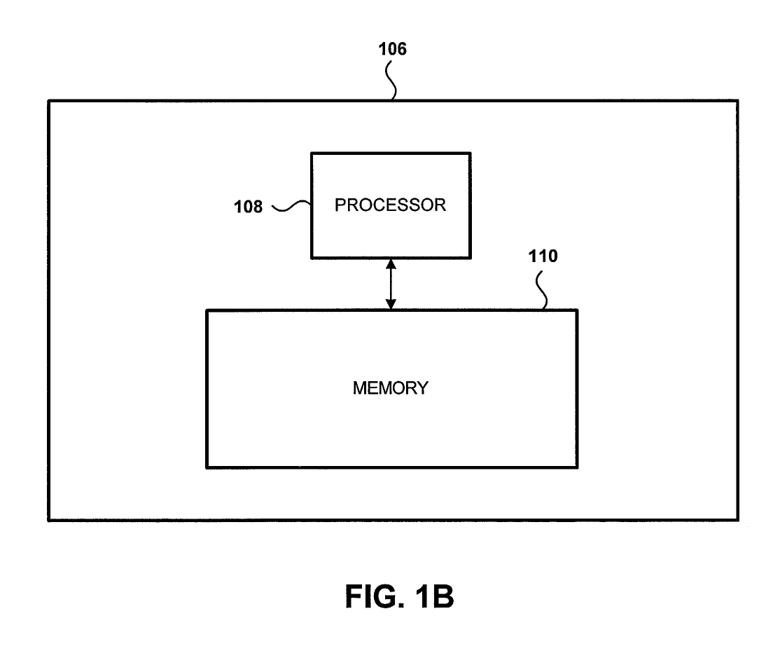

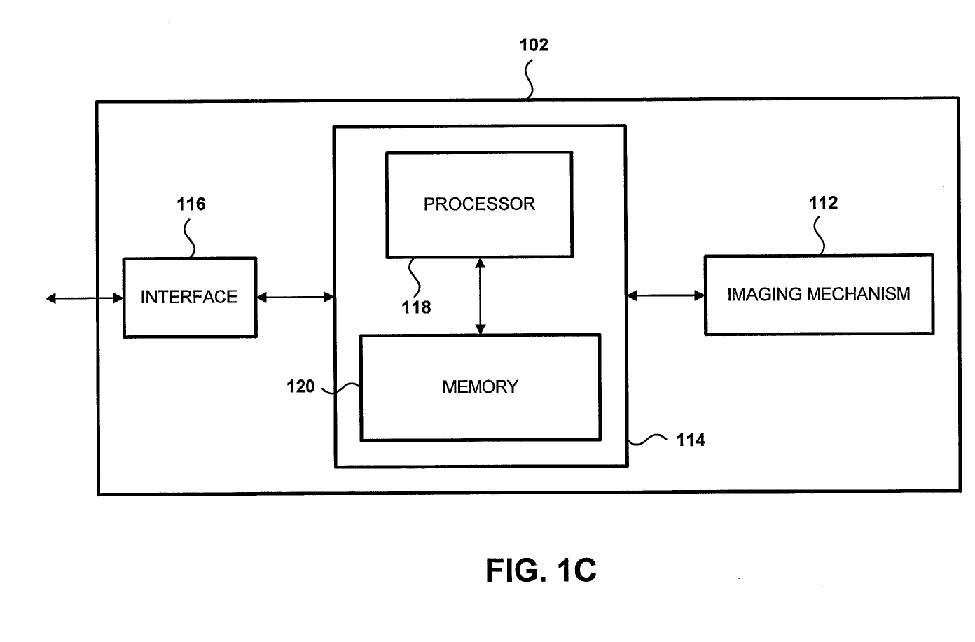

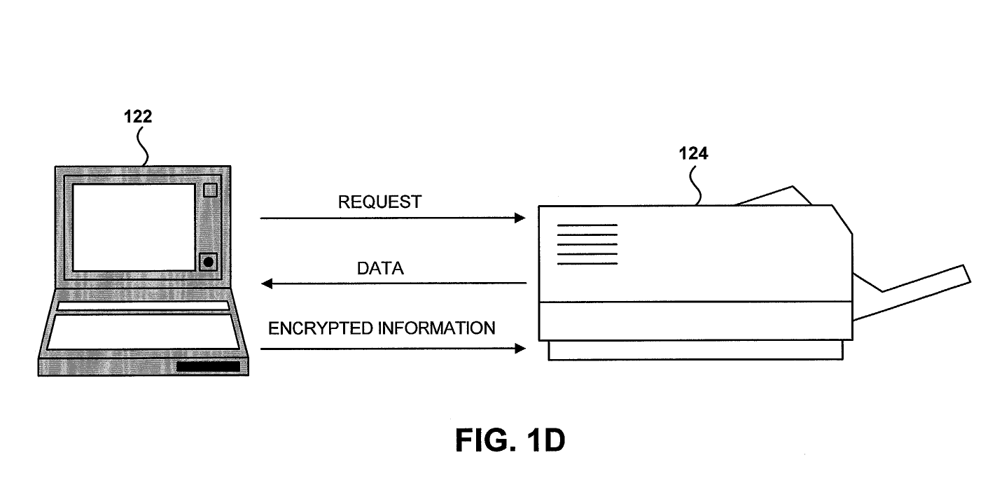

Shown in FIG. 1A is a simplified block diagram of an embodiment of the security system.

Shown in FIG. 1B is a high-level block diagram of an embodiment of a computing device.

Shown in FIG. 1C is a high-level block diagram of an embodiment of an imaging device.

Shown in FIG. 1D is a schematic representation of an embodiment of the security system.

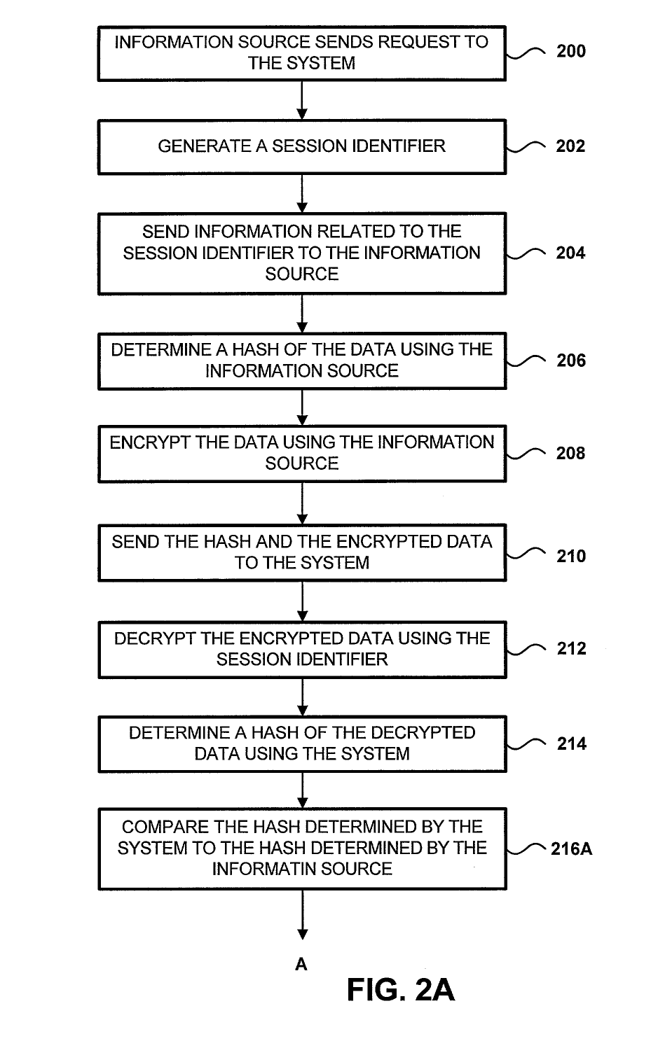

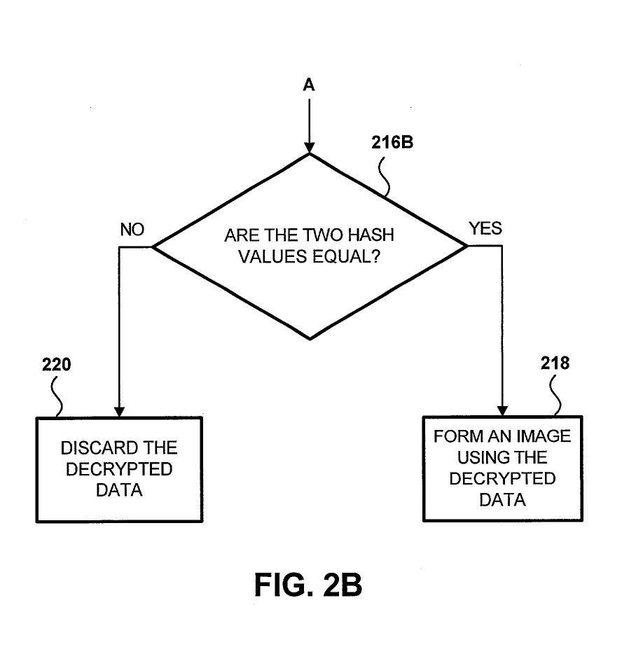

Shown in FIG. 2A and FIG. 2B is a high level flow diagram of a first method of using the embodiment of the security system.

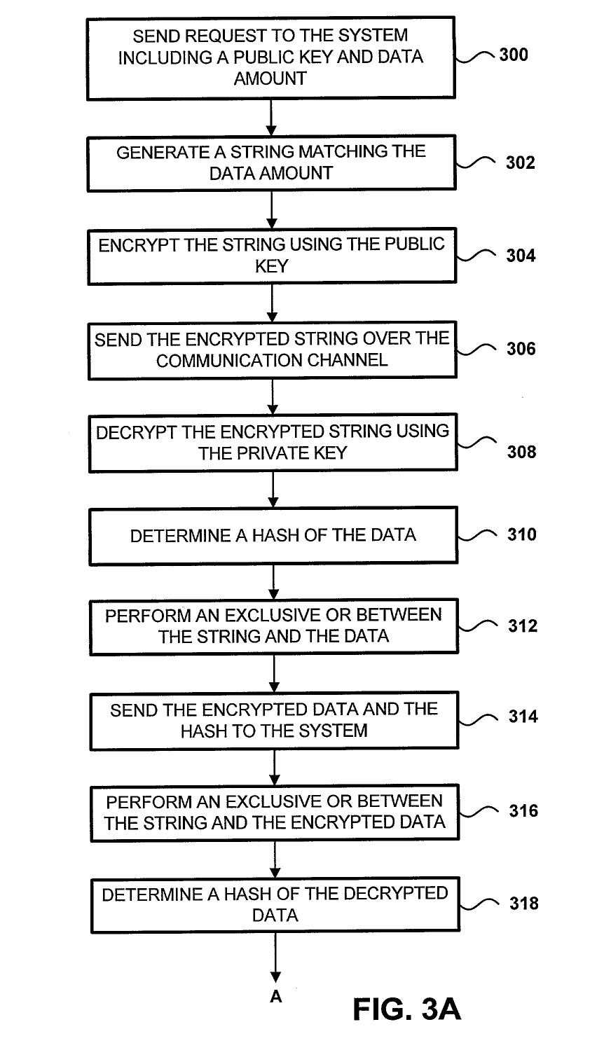

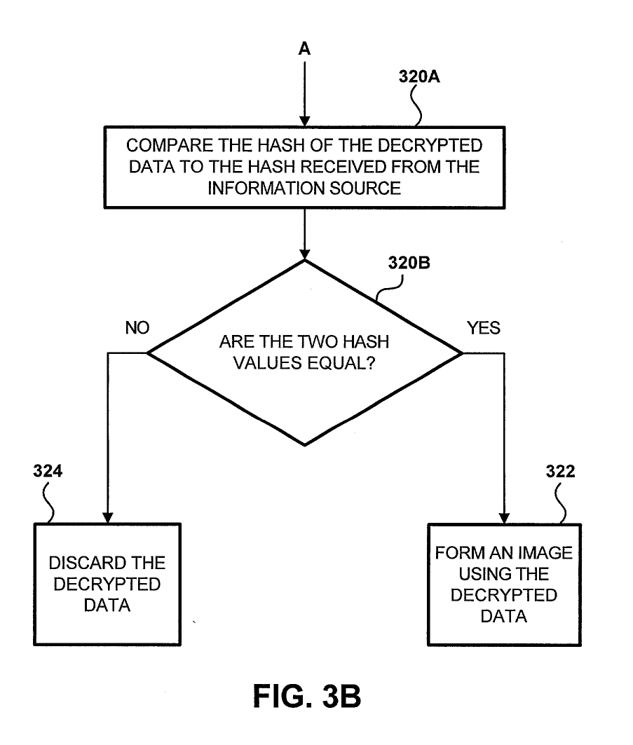

Shown in FIG. 3A and FIG. 3B is a high level flow diagram of a second method of using the embodiment the embodiment of the security system.

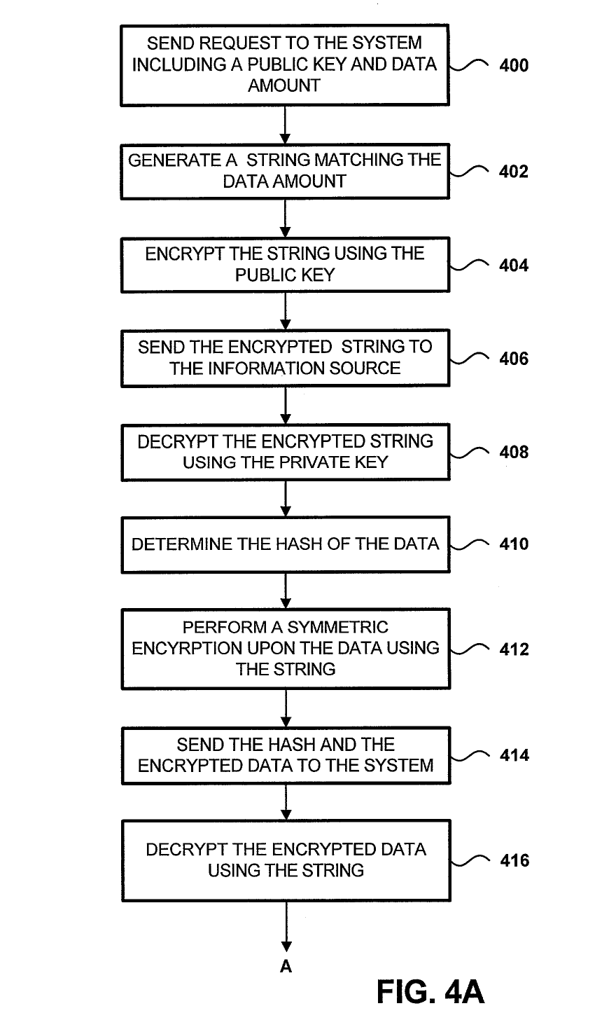

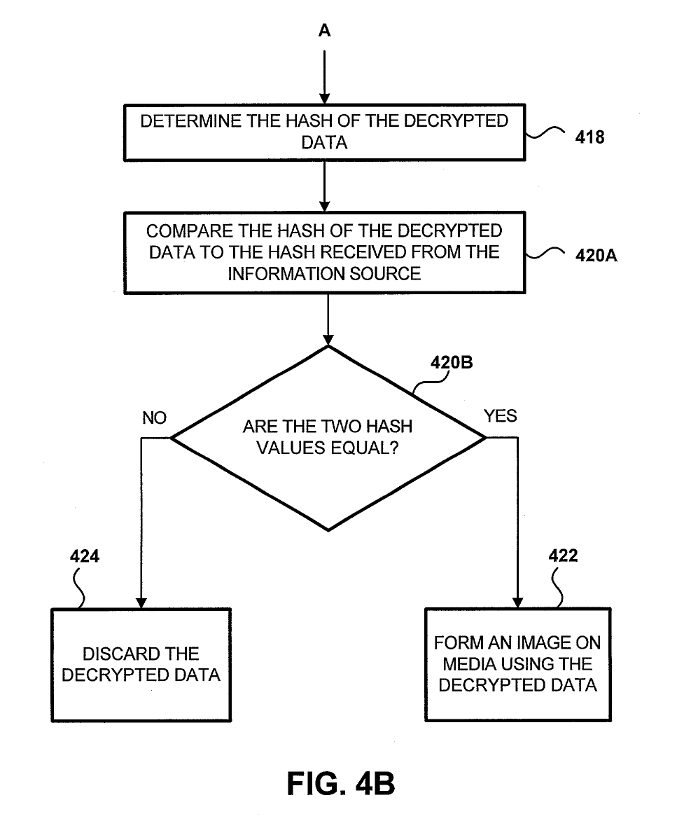

Shown in FIG. 4A and FIG. 4B is a high level flow diagram of a third method of using the embodiment of the security system.

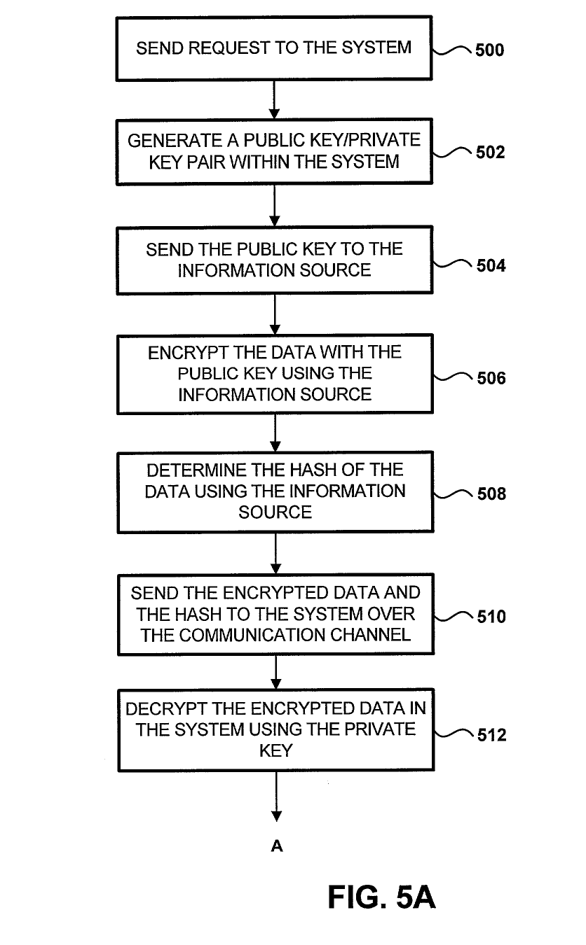

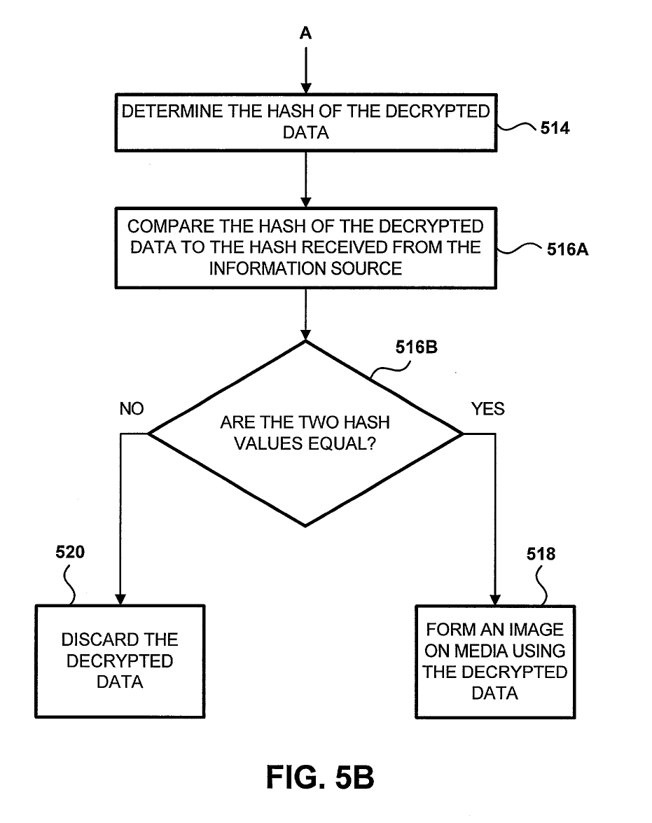

Shown in FIG. 5A and FIG. 5B is a high level flow diagram of a fourth method of using the embodiment of the security system.

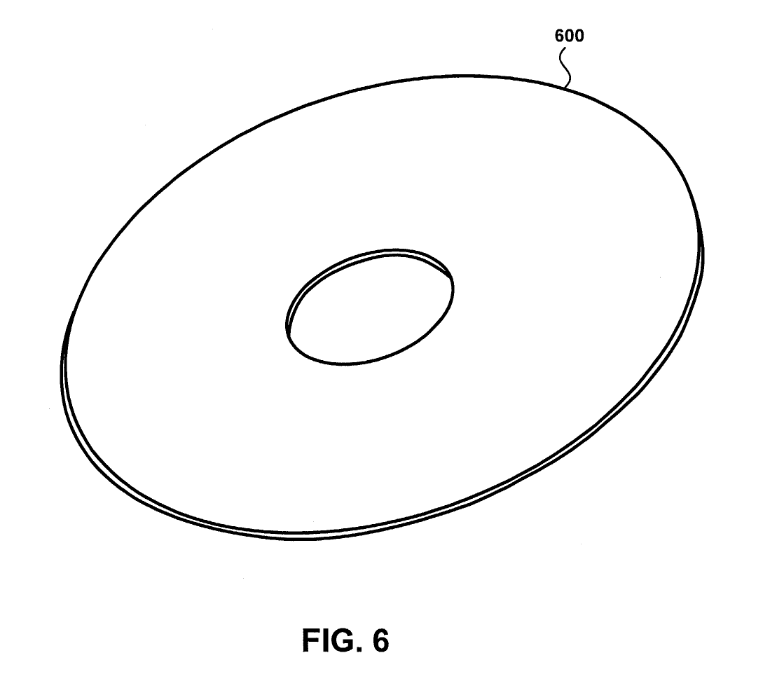

Shown in FIG. 6 is an embodiment of a computer readable medium.

### DETAILED DESCRIPTION OF THE DRAWINGS

It should be recognized that embodiments of the security system might be implemented through software or firmware executing on a processing device. The processing device may include a general purpose processor, such as a microprocessor. Alternatively, the processing device may include hardware specifically designed for the task, such as an application specific integrated circuit. Additionally, the processing device used to execute embodiments of the security system may be located within a computing device, such as a general purpose computer, or within an imaging device, such as an inkjet printer or an electrophotographic printer.

Shown in FIG. 1A is a simplified block diagram of an embodiment of the security system. Information source 100 represents a device capable of supplying data defining an image. Information source 100 could include a wireless device, such as a personal digital assistant, a server, or a portable computer, cell phone, or other embodiment of a computing device. System 101 is arranged to receive the information provided by information source 100. An embodiment of an imaging system, system 101, includes imaging device 102. Imaging device 102 is configured to receive the information provided by information source 100 corresponding to the image that is to be formed. Imaging device 102 could include, a printer, copier, plotter, facsimile machine, all-in-one device, or the like. The information provided by information source 100 is received by imaging device 102 over communication channel 104. Imaging device 102 either directly receives the information or could receive the information from another device, such as a computing device, that may be included within system 101. The computing device could include a network server or a personal computer, such as computer 106. The functions performed by system 101 to enhance security could be performed within imaging device 102, within computer 106 (if included within system 101), or performance of these functions could be partitioned between imaging device 102 and computer 106. FIG. 1 illustrates these alternative possibilities by the dashed lines connecting communication channel 104 to computer 106 and to imaging device 102. Communication channel 104 could be any communication channel that can be monitored to gather information about the data transmitted over the communication channel. For example, a digital or analog wireless communication channel would note be secure because the information transmitted over the communication channel could be monitored. Or, the Internet would be a communication channel that is not secure because information transmitted over it could be monitored.

Shown in FIG. 1B is a simplified block diagram of an embodiment of computer 106 that could be configured to be included within an embodiment of the security system. An embodiment of a processing device, such as processor 108, is coupled to an embodiment of a memory device, memory 110. Processor 108 executes firmware or software retrieved from memory 110 to perform the functions in the embodiment of the security system. Processor 108 could include, for example, a microprocessor or an ASIC.

Shown in FIG. 1C is a simplified block diagram of an embodiment of an imaging device, imaging device 102, that can form images on media. Imaging device 102 could be configured to be included within an embodiment of the security system. Imaging device 102 may include a color or monochrome inkjet printer, other types of printers such as color or monochrome electrophotographic printers, facsimile machines, digital copiers, dot matrix printers, or any device that can form an image on media. Imaging device 102 may be configured to form images at 300 dpi, 600 dpi, 1200 dpi, or other resolutions. A printer driver program that can execute in information source 100 converts the data (corresponding to the image) received from the application program into a form useable by imaging device 102 such as a page description language (PDL) file. The PDL file may include for example a file defined in HEWLETT PACKARD'S PCL-3 or PCL-5 format.

Imaging device 102 renders the PDL file to generate pixel data for each pixel of the image. For example, an embodiment of imaging device 102 may generate pixel data for color values for pixels forming the cyan, magenta, yellow, and black color planes. For this embodiment, the color values for each of the pixels in the color planes may range, for example, from 0 to 255. A halftoning operation may be performed upon the color values of the color planes to generate halftone data for the image. The halftone data can include binary data specifying for each of the pixels in each of the color planes whether or not colorant will be placed onto the pixel. Alternatively, the image may be formed using the pixel data for each of the pixels without halftoning. For this alternative, the quantity of colorant placed onto the pixel is directly related to the pixel data for the pixel. For an inkjet printer, the quantity of the colorant is controlled by the number of drops of ink placed onto the region of the media corresponding to the pixel. For an electrophotographic printer, the quantity of the colorant is controlled by the fractional portion of the region on the photoconductor corresponding to the pixel that is exposed and developed.

Included in the embodiment of imaging device 102 is an embodiment of an image forming mechanism, imaging mechanism 112. Imaging mechanism 112 includes the hardware necessary to place colorant (which can include black toner or black ink) onto media. For example, in the case of an electrophotographic printer, imaging mechanism 112 may include a photoconductor, developing devices for developing toner (the colorants in this embodiment of imaging mechanism 112), a photoconductor exposure system for forming a latent electrostatic image on the photoconductor, a charging device for charging the photoconductor, a transfer device for transferring toner from the photoconductor to media, and a fixing device for fixing toner to media. An embodiment of a controller, such as controller 114, coupled to imaging mechanism 112 controls the placement of colorant onto media by imaging mechanism 112. The output from the printer driver software executing in information source 100 is passed through interface 116 to controller 114. Controller 114 includes the capability to render the PDL file received from information source 100 to generate pixel data for each of the pixels forming the image. Controller 114 includes an embodiment of a processing device, such as processor 118 configured to execute firmware or software, or an application specific integrated circuit (ASIC), for controlling the placement of colorant onto media by imaging mechanism 112. In addition, controller 114 includes an embodiment of a memory device, such as memory 120 for storing pixel data.

Further detail on embodiments of imaging mechanisms used in electrophotographic imaging devices can be found in U.S. Pat. No. 5,291,251, entitled IMAGE DEVELOPMENT AND TRANSFER APPARATUS WHICH UTILIZED AN INTERMEDIATE TRANSFER FILM, issued to Storlie et. al., and assigned to Hewlett-Packard Company, and U.S. Pat. No. 5,314,774, entitled METHOD AND APPARATUS FOR DEVELOPING COLOR IMAGES USING DRY TONERS AND AN INTERMEDIATE TRANSFER MEMBER, issued to Camis, and assigned to Hewlett-Packard Company. Each of these two patents is incorporated by reference in their entirety into this specification.

In the case of an inkjet printer, imaging mechanism 112 may include an ink cartridge movably mounted on a carriage with its position precisely controlled by a belt driven by a stepper motor. An ink cartridge driver circuit coupled to the controller and the ink cartridge fires nozzles in the ink cartridges based upon signals received from the controller to place colorant on media according to the pixel data for the pixels forming each of the color planes. Further detail on embodiments of imaging mechanisms used in inkjet printers can be found in U.S. Pat. No. 6,082,854, entitled MODULAR INK-JET HARD COPY APPARATUS AND METHODOLOGY, issued to Axtell et al., and assigned to Hewlett-Packard Company, and U.S. Pat. No. 5,399,039, entitled INK-JET PRINTER WITH PRECISE PRINT ZONE MEDIA CONTROL, issued to Giles et al., and assigned to Hewlett-Packard Company. Each of these two patents is incorporated by reference in their entirety into this specification.

Typically, over a communication channel, such as communication channel 104, the device sending the information would perform some encryption operations in attempt to keep the information, even if it is monitored, from being understood by the monitoring party. However, as will be seen from the subsequent discussion, merely encrypting the information delivered over the communications channel may not sufficiently reduce the likelihood that the information can be understood by a party for whom it was not intended. Consider the case in which the primary security precaution is encryption of the information as it is transmitted over the communication channel followed by decryption and image formation in the receiving imaging device. If a party monitoring the communication channel is able to record the information transmitted from the device and at a later time resend this information over the communication channel, another copy of the image to which the information corresponds could be formed on the receiving imaging device. If the monitoring party had access to this imaging device, they could gain access to the unencrypted information. This technique to gain access to information is a type of replay attack.

To reduce the likelihood that this type of replay attack will be successful, a type of session identifier can be used. A session identifier acts as a marker that will indicate to the imaging device during an attempted replay attack that the information delivered in the replay attack was associated with a prior imaging operation involving the delivery of secure information. By using a session, the imaging device is able to recognize when a replay attack is underway and take the appropriate action. The appropriate action could include, for example, taking countermeasures against replay attacks after recognizing the replay attack. Or, the appropriate action could include gathering information about the entity conducting the replay attacks. Or, the appropriate action could include not responding to the attempt to perform the imaging operation, thereby saving time lost from performing the unauthorized imaging operation and the expense of the media that would have been used.

Shown in FIG. 1D is a schematic representation of the operation of an embodiment of the security system included for the purpose of providing a basic description of the operation of embodiments of the security system. In this embodiment, portable computer 122 makes a request to laser printer 124 to perform a print job. Depending upon the implementation of the embodiment of the security system, the request may include information related to a quantity of information defining the image that will be sent from portable computer 122 to perform the print job. In response to that request, laser printer 124 generates a session identifier associated with the request from portable computer 122. Laser printer 124 sends this session identifier (which may be encrypted or not encrypted depending on the characteristics of the session identifier) to portable computer 122. Using this session identifier, portable computer 122 encrypts the information defining the image. In addition, portable computer 122 determines a hash of the information. Portable computer 122 sends the hash of the information and the encrypted information to laser printer 124. Laser printer 124 decrypts the encrypted information and determines a hash of the information. Then, laser printer 124 compares the hash it determined with the hash received from portable computer 122. If the hash values are equivalent, then laser printer 124 performs the print job using the decrypted information. If the hash values are not equivalent, the information is discarded. Because the encryption of the information is performed using the session identifier generated by laser printer 124 and associated with the request to perform a print job, the susceptibility of laser printer 124 to replay attacks is reduced.

Shown in FIG. 2A and FIG. 2B is a high level flow diagram corresponding to operation of embodiments of the security system. First, in step 200, an information source sends a request through a communication channel for performing an imaging operation to an embodiment of an imaging system, used for performing the imaging operation. In addition, information related to the amount of data that will be transferred from the information source to the system for performing the imaging operation may be provided by the information source to the system. Next, in step 202, the system generates a session identifier associated with the request for performing the imaging operation. Then, in step 204, the system sends information related to the session identifier to the information source. Next, in step 206, the information source determines a hash of the data corresponding to the image that will be generated using the imaging device. The hash function used could be any of the possible types of hash functions, such as the MD5 hash function. Then, in step 208, the information source performs an encryption operation on the data corresponding to the image that will be generated to form encrypted data. The encryption operation makes use of the information related to the session identifier.

Next, in step 210, the information source sends the hash and the encrypted data to the system. Then, in step 212, the system decrypts the encrypted data to generate decrypted data using the session identifier. Next, in step 214, the system determines a hash of the decrypted data. Then, in step 216 (shown as 216a and 216b in FIG. 2A and FIG. 2B), the system compares the hash determined by the system using the decrypted data and the hash received from the information source over the communication channel. If the hash determined by the system matches the hash received from the information source over the communications channel, then, in step 218, the image is generated using the imaging device and the decrypted data. However, if the hash determined by the system does not match the hash received from the information source over the communication channel, then, in step 220, the decrypted data is discarded.

In the operation of the embodiment of the security system corresponding to FIG. 2A and FIG. 2B, the transfer of the encrypted data between the information source and the system is discussed in the context of transferring data corresponding to an entire image. It should be recognized that this embodiment of the data security system, as well as the other disclosed embodiments, could operate in an alternative manner. Some imaging devices have limited memory capacity for storing data received from an information source. For these types of imaging devices, the transfer of encrypted data corresponding to an image may be partitioned into segments and transferred through multiple transfers of a size that can fit into the available memory within the imaging device. The transfer of successive segments could occur when memory space becomes available in the imaging device because processing has been performed on at least part of the previous segment stored in the memory. The encryption performed by the information source using the information related to the session identifier is performed upon each of the segments. It should be recognized that the system could generate different session identifiers for the different segments that are transferred between the information source and the system or the system could generate a single session identifier for the transfer of all the segments of the data corresponding to the image.

Shown in FIG. 3A and FIG. 3B is a high level flow diagram corresponding to a method of operation for a first embodiment of the security system. First, in step 300, information device 100 sends a request for an imaging operation (either to computer 106 or to imaging device 102 included within system 101) over communication channel 104 for performing an imaging operation. Included with the request is the public key of a public key/private key pair associated with information device 100 and information related to a quantity of data that will be sent to system 101 for forming an image on media. Next, in step 302, imaging device 102 generates a string associated with this specific request for performing an imaging operation. The string generated could be a so called random string. A random string corresponds to a string generated independently of the information that it will be used to encrypt. That is, the random string is not derived from the data it will encrypt. The length of the string matches the number of units (e.g. bytes) of data that will be sent to system 101 by information source 100. The string is a type of session identifier because its composition is associated with the request for performing an imaging operation.

Then, in step 304, either or both of imaging device 102 or computer 106 encrypts the string using the public key provided by information source 100. Next, in step 306, the encrypted string is sent to information source 100 over communication channel 104. Then, in step 308, information source 100 decrypts the encrypted string using the private key of information source 100 to obtain the string. Next, in step 310, information source 100 determines the hash of the data that corresponds to the image. Then, in step 312, information source 100 performs an exclusive OR operation between the data that corresponds to the image and the string to generate the encrypted data. Next, in step 314, information source 100 sends the encrypted data and the hash of the data to system 101. Then, in step 316, system 101 (either or both within computer 106 or imaging device 102) decrypts the encrypted data received from information source 100 by performing an exclusive OR operation between the encrypted data and the string to generate decrypted data. Next, in step 318, system 101 (either or both within computer 106 or imaging device 102) determines the hash of the decrypted data. Then, in step 320 source 100. If they match, then in step 322, imaging device 102 forms an image on media corresponding to the decrypted data. If they do not match, then in step 324 the decrypted data is discarded.

The method disclosed in FIG. 3A and FIG. 3B provides protection from replay type attacks. Consider the situation in which information related to a previous imaging operation was intercepted during its transmission over communication channel 104. The information intercepted includes the hash of the data sent for the imaging operation and the encrypted form of the data for the imaging operation. The party intercepting the information wishes to have access to the decrypted form of the data. However, the party does not have the capability to defeat the encryption scheme to recover the data in unencrypted form. So, the party attempts to recover the data by requesting system 101 to perform an imaging operation using the intercepted hash and the intercepted encrypted form of the data. However, because system 101 generates a session identifier, associated with the new request to perform an imaging operation, that is different than the session identifier used in generating the intercepted encrypted data, the attempt will likely be unsuccessful.

When the encrypted data is decrypted using the session identifier generated in response to the intercepting party's request for an imaging operation, the decrypted data will be unintelligible. The hash of the unintelligible decrypted data will not match the hash intercepted by the party and provided to system 101. Thus, applying the method disclosed in FIG. 3A and FIG. 3B to the intercepted hash and the encrypted data reduces the likelihood of the intercepting party having access to the data.

Shown in FIG. 4A and FIG. 4B is a high level flow diagram corresponding to a method of operation for a second embodiment of the security system. First, in step 400, information source 100 sends a request to imaging device 102 (either directly or indirectly through computer 106) over communication channel 104 for performing an imaging operation. Included with the request is the public key of a public key/private key pair associated with information source 100 and information related to the amount of data that will be sent to system 101 for forming an image on media. Next, in step 402, imaging device 102 generates a string associated with this specific request for performing an imaging operation. It is not required that the length of the string matches the number of units (e.g. bytes) of data that will be sent to system 101 by information source 100. The string is a type of session identifier.

Then, in step 404, either or both of imaging device 102 or computer 106 encrypts the string using the public key provided by information source 100. Next, in step 406, the encrypted string is sent to information source 100 over communication channel 104. Then, in step 408, information source 100 decrypts the encrypted string using the private key of information source 100 to obtain the string. Next, in step 410, information source 100 determines the hash of the data that corresponds to the image. Then, in step 412, information source 100 performs an encryption upon the data that corresponds to the image using a symmetric encryption technique. Any of the possible types of symmetric encryption schemes may be used, such as DES, with the decrypted string used as the key, to generate the encrypted data. In addition, the same string is used as the key to generate the decrypted data from the encrypted data. Next, in step 414, information source 100 sends the encrypted data and the hash of the data to system 101. Then, in step 416, system 101 (either or both within computer 106 or imaging device 102) decrypts the encrypted data received from information source 100, using the string as the decryption key, to generate decrypted data for the symmetric encryption scheme. Next, in step 418, system 101 (either or both within computer 106 or imaging device 102) determines the hash of the decrypted data. Then, in steps 420a and 420b, the hash determined from the decrypted data is compared to the hash of the data received from information source 100. If they match, then in step 422, imaging device 102 forms an image on media corresponding to the decrypted data. If they do not match, then in step 424 the decrypted data is discarded.

The method disclosed in FIG. 4A and FIG. 4B provides protection from replay type attacks. Consider the situation in which information related to a previous imaging operation was intercepted during its transmission over communication channel 104. The information intercepted includes the hash of the data sent for the imaging operation and the encrypted form of the data for the imaging operation. The party intercepting the information wishes to have access to the decrypted form of the data. However, the party does not have the capability to defeat the encryption scheme to recover the data in unencrypted form. So, the party attempts to recover the data by requesting system 101 to perform an imaging operation using the intercepted hash and the encrypted form of the data. However, because system 101 generates a session identifier, associated with the new request to perform an imaging operation, that is different than the session identifier used in generating the intercepted encrypted data, the attempt will be unsuccessful.

When the encrypted data is decrypted using the session identifier generated in response to the intercepting party's request for an imaging operation as the decryption key, the decrypted data will be unintelligible. The hash of the unintelligible decrypted data will not match the hash intercepted by the party and provided to system 101. Thus, applying the method disclosed in FIG. 4A and FIG. 4B to the intercepted hash and the encrypted data reduces the likelihood of the intercepting party having access to the data.

Shown in FIG. 5A and FIG. 5B is a high level flow diagram corresponding to a method of operation for a third embodiment of the security system. First, in step 500, information device 100 sends a request to system 101 (either to computer 106 or imaging device 102) over communication channel 104 for performing an imaging operation. Included with the request is information related to the amount of data that will be sent to system 101 for forming an image on media. Next, in step 502, either or both of imaging device 102 or computer 106 included within system 101, generates a public key/private key pair associated with this specific request for performing an imaging operation. The public key/private key pair acts as a type of session identifier.

Then, in step 504, the public key is sent to information source 100 over communication channel 104. Then, in step 506, information source 100 encrypts the data corresponding to the image that is to be formed using the public key generated by and received from system 101. Next, in step 508, information source 100 determines the hash of the data that corresponds to the image. Next, in step 510, information source 100 sends the encrypted data and the hash of the data to system 101. Then, in step 512, system 101 (either or both within computer 106 or imaging device 102) decrypts the encrypted data received from information source 100 using the private key of the public key/private key pair generated for the session. Next, in step 514, system 101 (either or both within computer 106 or imaging device 102) determines the hash of the decrypted data. Then, in step 516a and step 516b, the hash determined from the decrypted data is compared to the hash of the data received from information source 100. If they match, then in step 518, imaging device 102 forms an image on media corresponding to the decrypted data. If they do not match, then in step 520 the decrypted data is discarded.

The method disclosed in FIG. 5A and FIG. 5B provides protection from replay type attacks. Consider the situation in which information related to a previous imaging operation was intercepted during its transmission over communication channel 104. The information intercepted includes the hash of the data sent for the imaging operation and the encrypted form of the data for the imaging operation. The party intercepting the information wishes to have access to the decrypted form of the data. However, the party does not have the capability to defeat the encryption scheme to recover the data in unencrypted form. So, the party attempts to recover the data by requesting system 101 to perform an imaging operation using the intercepted hash and the encrypted form of the data. However, because system 101 generates a session identifier, associated with the new request to perform an imaging operation, that is different than the session identifier used in generating the intercepted encrypted data, the attempt will likely be unsuccessful.

When the encrypted data is decrypted using the session identifier generated in response to the intercepting party's request for an imaging operation, the decrypted data will be unintelligible. The hash of the unintelligible decrypted data will not match the hash intercepted by the party and provided to system 101. Thus, applying the method disclosed in FIG. 5A and FIG. 5B to the intercepted hash and the encrypted data reduces the likelihood of the intercepting party having access to the data.

Processor executable instructions used to perform the operations for an embodiment of the security system can be stored on an embodiment of a storage device. The embodiment of the storage device could include an embodiment of a computer readable medium. The computer readable medium could include a medium readable electrically, optically, magnetically or electromagnetically. An embodiment of the computer readable medium could include a compact disc (CD), a floppy disk, a disk platter within a hard disk drive, or a magnetic tape within a magnetic tape drive. Shown in FIG. 6 is an embodiment of a computer readable medium, such as compact disk 600, having processor executable instructions for operating an embodiment of the security system. Alternatively, the embodiment of the computer readable medium could include semiconductor memory. The processor executable instructions could be distributed by physically delivering the computer readable memory to the end user or by allowing a user to download the program from a storage device, such as a hard disk drive, through a wide area network or a local area network.

Although several embodiments of the security system have been illustrated and described, it is readily apparent to those of ordinary skill in the art that various modifications may be made to this embodiment without departing from the scope of the appended claims.

What is claimed is:

1. A system, comprising:
an information source configured to form encrypted information from information corresponding to an image using at least a part of data and to form a first hash of the information;
an imaging system configured to generate the data, to form decrypted information from the encrypted information using at least part of the data, to form a second hash from the decrypted information and to form an image on media if the first hash matches the second hash; and
a communication channel through which the encrypted information, the first hash, and at least part of the data move between the information source and the imaging system.

2. The system as recited in claim 1, wherein:
the information source includes a configuration to send a public key to the imaging system over the communication channel associated with a request to perform an imaging operation;
the data includes a string; and
the imaging system includes a configuration to generate an encrypted string using the public key and to send the encrypted string to the information source over the communication channel.

3. The system as recited in claim 2, wherein:
the information source includes a configuration to decrypt the string using a private key corresponding to the public key and a configuration to encrypt the information with symmetric encryption using the string; and
the imaging system includes a configuration to decrypt the encrypted information using the string used for the symmetric encryption.

4. The system as recited in claim 2, wherein:
a size of the string corresponds to a quantity of the information;
the information source includes a configuration to decrypt the string using a private key corresponding to the public key; and
the information source includes a configuration to encrypt the information by performing an exclusive OR between the string and the information.

5. The system as recited in claim 4, wherein:
the imaging system includes a configuration to decrypt the encrypted information by performing an exclusive OR between the string and the encrypted information; and
the imaging system includes a configuration to form an image corresponding to the decrypted information if the first hash equals the second hash.

6. The system as recited in claim 1, wherein:
the data includes a public key and a private key corresponding to the public key; and
the imaging system includes a configuration to send the public key to the information source in response to a request to perform an imaging operation.

7. The system as recited in claim 6, wherein:
the information source includes a configuration to form the encrypted information using the public key; and
the imaging system includes a configuration to decrypt the encrypted information using the private key.

8. A method, comprising:
generating data with an imaging system in response to a request from an information source;
decrypting encrypted information received from the information source, using the imaging system and at least part of the data, to form decrypted information;
forming a second hash from the decrypted information using the imaging system; and
forming an image on media using the decrypted information if the second hash equals a first hash received from the information source.

9. The method as recited in claim 8, further comprising:
with the data including a string, encrypting the string with the imaging system using a public key received from the information source to form an encrypted string; and
sending the encrypted string to the information source.

10. The method as recited in claim 9, wherein:
the information source decrypts the encrypted string to recover the string using a private key corresponding to the public key;
the information source forms the encrypted information by applying symmetric encryption to information corresponding to the image using the string;
the information source forms the first hash using the information; and
the information source sends the encrypted information and the first hash to the imaging system.

11. The method as recited in claim 10, wherein:
the string includes a random string with respect to the information; and
decrypting the encrypted information includes using the random string used for symmetric encryption.

12. The method as recited in claim 9, wherein:
the request from the information source indicates a quantity of the information corresponding to the image;
generating the data includes generating the string having a length matching the quantity of the information;
the information source decrypts the encrypted string to recover the string using a private key corresponding to the public key;
the information source forms the encrypted information by performing an exclusive OR between the information and the string;
the information source forms the first hash using the information; and
the information source sends the encrypted information and the first hash to the imaging system.

13. The method as recited in claim 12, wherein:
the string includes a random string with respect to the information; and
decrypting the encrypted information includes performing an exclusive OR between the encrypted information and the string.

14. The method as recited in claim 8, further comprising:
with the data including a public key and a private key, sending the public key to the information source from the imaging system.

15. The method as recited in claim 14, wherein:
the information source forms the encrypted information from information corresponding to the image using the public key; and
the information source forms the first hash using the information.

16. The method as recited in claim 15, wherein:
decrypting the encrypted information includes using the private key.

17. The method as recited in claim 8, wherein:
the imaging system includes an imaging device configured to generate the data, decrypt the encrypted information, form the second hash, and form the image on the media.

18. The method as recited in claim 8, wherein:
the imaging system includes a computing device to generate the data, decrypt the encrypted information, and form the second hash; and
the imaging system includes an imaging device configured to form the image on the media.

19. An imaging device, comprising:
an interface arranged to receive encrypted data;
a memory configured to store the encrypted data and decrypted data;
a processing device operatively associated with the memory and configured to form the decrypted data from the encrypted data using a session identifier generated in response to a request to form an image, configured to form a first hash from the decrypted data, and configured to compare the first hash to a second hash formed from data used to form the encrypted data; and
an imaging mechanism coupled to the processing device and configured to form an image on media corresponding to the decrypted data.

20. The imaging device as recited in claim 19, wherein:
the session identifier includes a string;
the processing device includes a configuration to form the decrypted data from the encrypted data using the string used for symmetric encryption of the data with the string; and
the processing device includes a configuration to control the imaging mechanism to form the image on the media if the first hash equals the second hash.

21. The imaging device as recited in claim 19, wherein:
the request to form the image includes information indicating a quantity of the data;
the session identifier includes a string having a length matching the quantity of the data;
the processing device includes a configuration to form the decrypted data from the encrypted data by performing an exclusive OR between the encrypted data and the string; and
the processing device includes a configuration to control the imaging mechanism to form the image on the media if the first hash equals the second hash.

22. The imaging device as recited in claim 19, wherein:
the session identifier includes a public key and a private key;
the processing device includes a configuration to form the decrypted data using the private key; and
the processing device includes a configuration to control the imaging mechanism to form the image on the media if the first hash equals the second hash.

23. A system to form an image using data from an information source, comprising:
means for generating a session indicator in response to a request from the information source;
means for decrypting encrypted data received from the information source;
means for generating a second hash;
means for comparing a first hash formed by the information source to the second hash; and
means for forming the image on the media using the data if the first hash equals the second hash.

24. A system to receive transformed data related to an image from a first computing device, comprising:
a second computing device including a memory for storing the transformed data, where the transformed data includes encrypted data and a first hash formed from data used to form the encrypted data, and including a processing device configured to generate decrypted data from the encrypted data using a session indicator generated by the processing device, configured to determine a second hash using the decrypted data; and
an imaging device coupled to the second computing device and configured to form an image on media using the decrypted data sent from the second computing device if the first hash equals the second hash.

25. The system as recited in claim 24, wherein:
the session indicator includes a public key and a private key generated in response to a request by the first computing device to form the image; and
with the first computing device configured to generate the encrypted data from the data using the public key, the second computing device includes a configuration to generate the decrypted data using the private key and to compare the first hash to the second hash to determine if the first hash equals the second hash.

26. The system as recited in claim 24, wherein:
the session indicator includes a string generated in response to a request by the first computing device to form the image; and
with the first computing device configured to generate the encrypted data from the data with symmetric encryption using the string, the second computing device includes a configuration to decrypt the encrypted data with the string used for the symmetric encryption and to compare the first hash to the second hash to determine if the first hash equals the second hash.

27. The system as recited in claim 24, wherein:
the session indicator includes a string generated in response to a request by the first computing device to form the image, where a length of the string matches a quantity of the data; and
with the first computing device configured to generate the encrypted data from the data by performing an exclusive OR between the data and the string, the second computing device includes a configuration to decrypt the encrypted data by performing an exclusive OR between the encrypted data and the string and to compare the first hash to the second hash to determine if the first hash equals the second hash.

28. A storage device, comprising:
a computer readable medium; and
processor executable instructions stored on the computer readable medium and configured to generate data using an imaging system in response to a request from an information source, configured to decrypt encrypted information received from the information source, using the imaging system and at least part of the data, to form decrypted information, configured to form a second hash from the decrypted information using the imaging system, and configured to form an image on media using the decrypted information if the second hash equals a first hash received from the information source.

29. The storage device as recited in claim 28, wherein:
the data includes a string; and
the computer executable instructions include a configuration to encrypt the string with the imaging system using a public key received from the information source to form an encrypted string and send the encrypted string to the information source.

30. The storage device as recited in claim 29, wherein:
the computer executable instructions include a configuration to decrypt the encrypted information using the string used for symmetric encryption of the information.

31. The storage device as recited in claim 29, wherein:
the computer executable instructions include a configuration to generate the string having a length corresponding a quantity of the information and a configuration to decrypt the encrypted information by performing an exclusive OR between the encrypted information and the string.

32. The storage device as recited in claim 28, wherein:
the data includes a public key and a private key; and
the computer executable instructions include a configuration to send the public key to the information source and to decrypt the encrypted information using the private key.

33. A printer, comprising:
an interface arranged to receive encrypted data;
a memory configured to store the encrypted data and decrypted data;
a processing device operatively associated with the memory and configured to form the decrypted data from the encrypted data, using a random string generated in response to a request to print, by performing an exclusive OR operation between the random string and the encrypted data, where a size of the random string equals a quantity of data used to form the encrypted data, with the processing device configured to form a first hash from the decrypted data, and configured to compare the first hash to a second hash formed from the data; and
an imaging mechanism coupled to the processing device and configured to form an image on media corresponding to the decrypted data.
